(19) United States
(12) Patent Application Publication
(10) Pub. No.: US 2009/0323523 A1
(43) Pub. Date: Dec. 31, 2009

(54) Method and Apparatus for Optimizing Station Data in Mobile Communication Network, and Computer-Readable Storage Medium for Computer Program

(75) Inventors: Yumiko Tatezono, Fukuoka (JP); Masaaki Ishibashi, Fukuoka (JP); Kousuke Sakamoto, Fukuoka (JP); Shinji Tanaka, Fukuoka (JP); Yukimasa Takahira, Fukuoka (JP); Koji Yoshioka, Fukuoka (JP)

Correspondence Address: KATTEN MUCHIN ROSENMAN LLP, 575 MADISON AVENUE, NEW YORK, NY, 10022-2585, US

(73) Assignee: FUJITSU LIMITED, Kawasaki-shi (JP)

(21) Appl. No.: 12/392,260

(22) Filed: Feb. 25, 2009

(30) Foreign Application Priority Data
Jun. 25, 2008 (JP) 2008-165935

(51) Int. Cl. G08C 15/00

(52) U.S. Cl. 370/229

(57) ABSTRACT

In order to prevent occurrence of congestion derived from an unexpected or temporary factor as much as possible, a computer is allowed to execute a process of acquiring actual operational information indicating an actual operational history of a mobile communication network; a process of acquiring setting data corresponding to station data set for each node of the mobile communication network; a process of extracting, on the basis of the actual operational information and the setting data, a node or a channel expected to have increase in traffic and a node or a channel having a margin in traffic; a process of creating station data optimized in consideration of change of traffic to be set for each extracted node; and a process of transferring the created station data to the corresponding node for update.

### CROSS-REFERENCE TO RELATED APPLICATION

This application is based upon and claims the benefit of priority of the prior Japanese Patent Application No. 2008-165935, filed on Jun. 25, 2008, the entire contents of which are incorporated herein by reference.

### FIELD

The embodiment discussed herein is related to a method, an apparatus and a computer program employed for optimizing station data used in a mobile communication network.

### BACKGROUND

A network operational data creation system has been conventionally provided for creating various operational data used in a mobile communication network NS. Such a network operational data creation system creates operational data necessary for operations and maintenance/monitor of core network system devices and radio access system devices in, for example, the entire IMT-2000 system.

In the mobile communication network NS, station data files are created by a person in charge of maintenance on the basis of the architecture of the network and network operational facilities planning information including planning of increase/decrease of radio network controllers (RNC) or radio base stations (NODE-B). In the network operational facilities planning information, the number of accommodated lines and the line bandwidth (transmission capacity or transmission rate) of a radio base station are determined by estimating the number of terminals that can be accommodated in a cell area and a necessary line bandwidth of the radio base station on the basis of data mart information (collected, for example, once a month) of each area managed by a network service planning/operating division.

In accordance with explosive increase of demands for the mobile communication service, the number of subscribers and the communication traffic of the mobile communication network have been abruptly increasing. Owing to such increase, it is necessary to rapidly expand the service providing area and to increase the capacity of the network.

In regard to traffic control of the mobile communication network, the following bandwidth control is proposed: The traffic is measured with a traffic monitoring device, and when the traffic increases beyond an allocated channel bandwidth and the bandwidth of the communication path needs to be increased, a data transfer channel is switched to a channel with a larger bandwidth (Japanese Laid-open Patent Publication No. 2000-295276).

Alternatively, a system is proposed to build a new server for solving a bottle neck of traffic when the bottle neck is detected in monitoring the traffic on a network (Japanese Laid-open Patent Publication No. 8-13781).

In the aforementioned conventional techniques, however, it is disadvantageously difficult to prevent occurrence of congestion caused by an unexpected or temporary factor.

For example, in an event such as a concert or a baseball game, or in an evacuation site established in a disaster, accesses from communication terminals in number exceeding the number of accommodated lines are unexpectedly made, and sometimes the lines may become too busy to get through or may be down due to congestion.

The currently employed IMT-2000 radio access network does not have a notification path to the network operational data creation system to be used in the case of unexpected lack of the number of accommodated lines or the line bandwidth, and hence has a problem that it cannot rapidly cope with abrupt traffic change. In other words, the current network has problems of lack of flexibility on network resource allocation and lack of real-time properties against change in the network.

Furthermore, in the case where the service is interrupted in the whole area because of a trouble occurring in a radio base station, it is necessary, as an emergency countermeasure, to change the antenna angle of an adjacent radio base station to an upper level so as to increase the covering area by increasing the transmission power. In this case, however, a person in charge of maintenance should re-create station data and the re-created station data should be transmitted to the radio base station, which makes it difficult to rapidly cope with the trouble.

Alternatively, a portable radio base station may be provided as another emergency countermeasure, but it is also difficult to rapidly cope with the trouble with this countermeasure because it costs much and it takes suitable time from the provision to the start of the service.

Furthermore, the use bandwidth is conventionally systematically changed on the basis of the increase/decrease trend of traffic. At this point, a person in charge of maintenance should determine whether or not the sum of the use bandwidth of one radio base station and the use bandwidth of a radio base station working under the former radio base station exceeds the maximum bandwidth value of an upper level radio base station. Also in this case, there are problems of low work efficiency due to manual calculation of the use bandwidths and the like, lack of accuracy due to the manual work and lack of the real-time properties against change in the network.

### SUMMARY

According to an aspect of an embodiment of the invention, a computer-readable storage medium storing a computer program for optimizing station data used in a mobile communication network, the computer program allowing a computer to execute a process acquiring actual operational information indicating an actual operational history of the mobile communication network, a process acquiring setting data corresponding to station data set for each node of the mobile communication network, a process extracting, on the basis of the actual operational information and the setting data, a node or a channel expected to have increase in traffic and a node or a channel having a margin in traffic, a process creating station data optimized in consideration of change of traffic to be set for the extracted node or a node including the extracted channel, and a process transferring the created station data to the corresponding node for update.

The object and advantages of the embodiment will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating the rough architecture of a mobile communication network system.

FIG. 2 is a block diagram illustrating architectures of respective systems included in a maintenance network.

FIG. 3 is a diagram illustrating examples of network information stored in a network information storage unit.

FIG. 4 is a diagram illustrating examples of statistical information stored in a statistical information storage unit.

FIG. 5 is a diagram illustrating examples of station set information on bandwidth values.

FIG. 6 is a diagram illustrating examples of station set information on location information.

FIG. 7 is a diagram illustrating examples of threshold value data stored in a threshold value data storage unit.

FIGS. 8A and 8B are diagrams illustrating examples of past optimization information stored in a past optimization information storage unit.

FIG. 9 is a diagram illustrating an example of event information stored in an event information storage unit.

FIG. 10 is a diagram illustrating an example of event actual information.

FIGS. 11A and 11B are diagrams illustrating examples of a device number analyzing order table.

FIG. 12 is a diagram illustrating examples of virtual channel management information.

FIG. 13 is a diagram explaining a virtual path and a virtual channel.

FIG. 14 is a flowchart illustrating the rough flow of a station data optimization process.

FIG. 15 is a flowchart illustrating the rough flow of a set bandwidth value optimization process.

FIG. 16 is a flowchart of an exemplified operation of the mobile communication network system.

FIG. 17 is a flowchart illustrating another exemplified flow of the station data optimization process.

FIG. 18 is a flowchart illustrating an exemplified flow of an optimization process for a bandwidth value of station data.

FIG. 19 is a flowchart illustrating a flow of a station data optimization process employed when an event is held.

FIG. 20 is a diagram explaining a recording medium used for storing a computer program.

### DESCRIPTION OF EMBODIMENT(S)

### I. Mobile Communication Network System

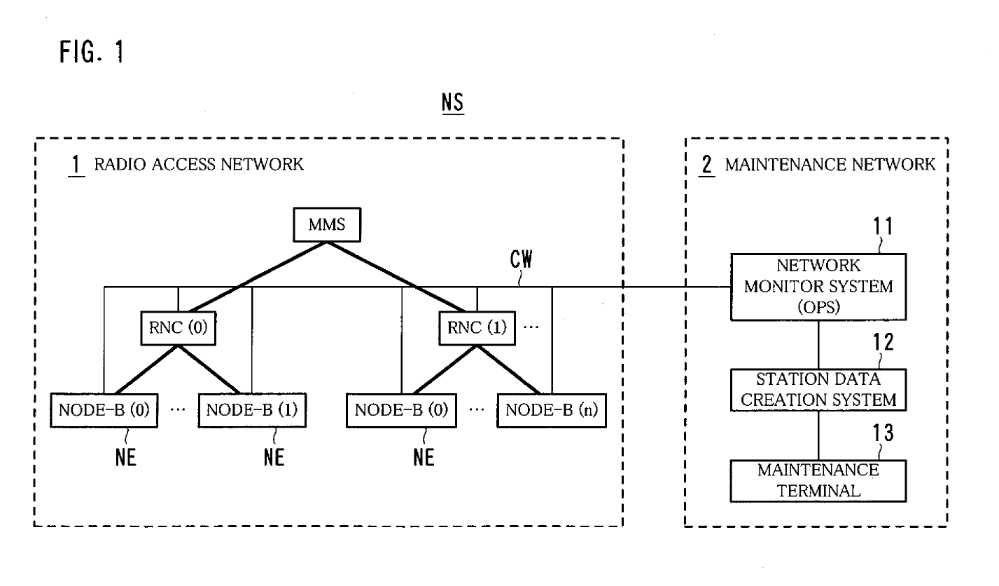

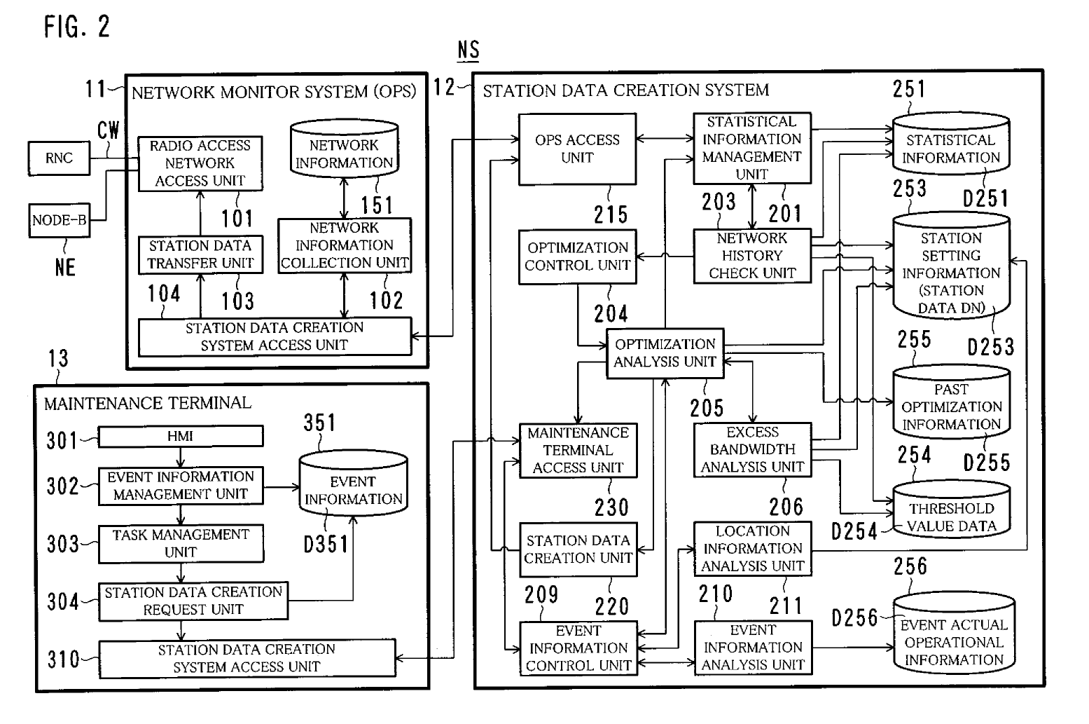

FIG. 1 is a diagram illustrating the rough architecture of a mobile communication network system NS according to the embodiment, and FIG. 2 is a block diagram illustrating architectures of respective systems included in a maintenance network 2.

In FIG. 1, the mobile communication network system NS includes a radio access network 1 and the maintenance network 2.

The radio access network 1 includes a switching center MMS (mobile multimedia switching center), a plurality of radio network controllers RNC and a plurality of nodes NE (Node-B: radio base station) working under each radio network controller RNC. Although merely one hierarchy of the nodes NE is illustrated in FIG. 1, the nodes NE may be provided in a plurality of hierarchies.

Each radio network controller RNC controls the nodes NE provided thereunder as well as connects a line with another radio network controller RNC or another switching center MMS for relaying a call or communication. Each radio network controller RNC controls, for example, a plurality of nodes NE for incoming/outgoing connection control, clearing control and diversity handover control.

Each node NE performs radio communication with mobile terminals (not illustrated) present in its covering area for relaying a call or communication.

Herein, in referring to a specific radio network controller RNC or a specific node NE, (0), (1), (2), . . . or (n) is added at the end. For example, a “node Node-B(0)” illustrated in a leftmost portion of FIG. 1 is described as a “node NE(0)” or merely “NE(0)”.

A memory of each node NE stores station data DN, that is, parameters used in controlling the node NE (i.e., connection information). The antenna power, the bandwidth value (the bandwidth), the antenna wave angle and the like of each node NE are controlled on the basis of the station data DN. It is noted that “station data” herein is a concept including a “station data file”.

The maintenance network 2 includes a network monitor system 11, a station data creation system 12 and a maintenance terminal 13.

The network monitor system 11 is connected to the switching center MMS, the radio network controllers RNC and the nodes NE through a maintenance line CW for monitoring the radio access network 1. Furthermore, it transfers station data DN created in the station data creation system 12 to nodes NE and the like through the maintenance line CW. It is noted that the function of the network monitor system 11 itself is conventionally known.

The station data creation system 12 creates station data DN on the basis of data input by a person in charge of maintenance and transfers the created station data DN to the network monitor system 11. In this embodiment in particular, the station data creation system 12 analyzes the operational history of the radio access network 1, deduces an optimum value, for example, an optimum bandwidth value, of setting data DNS (a parameter) set as station data DN, such as the antenna power, the bandwidth value or the antenna wave angle, and creates station data DN by using the deduced optimum value.

The maintenance terminal 13 is a terminal device used by a person in charge of maintenance in changing the station data DN or the like.

Referring to FIG. 1, when a mobile terminal working under the node NE(0) is to be accessed, if the network of the node NE(0) working under the radio network controller RNC(0) is congested so much that the access cannot be made, allocation of network resources is changed by changing the station data DN. In this embodiment, a case where the congestion of a network is reduced by changing the station data DN will be exemplified. In this particular case, a “bandwidth value” is utilized as the station data DN.

Since it is possible to change the station data DN of the radio network controllers RNC and the nodes NE included in the radio access network 1, any of various items of the station data DN apart from the “bandwidth value” may be changed on a real-time basis.

It is noted that each of the network monitor system 11, the station data creation system 12 and the maintenance terminal 13 is constructed from a computer system or a server including a processor, a memory, an input device, a display device, an interface device and the like. Alternatively, it may be constructed from a computer system provided with appropriate hardware. The function of each of these components can be realized through software by executing a program (a computer program) stored in a RAM or a ROM by a CPU provided in the computer system. Alternatively, the function may be realized by a hardware circuit included in or dedicated to the computer system or through a combination of hardware and software.

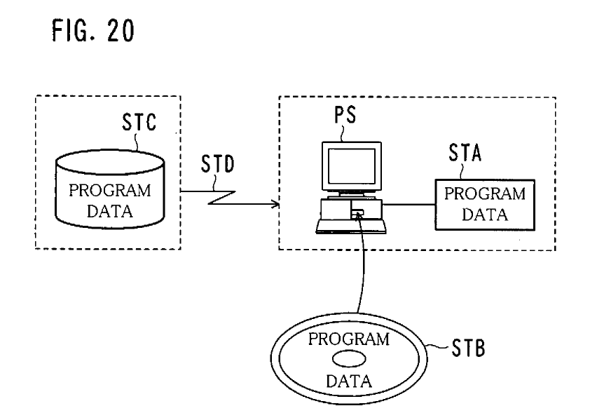

In such a computer system, the program for realizing each function can be stored in a recording medium STA, STB or STC such as a semiconductor memory, a hard disk, a CD-ROM, a flexible disk or a magneto-optical disk as illustrated in FIG. 20. The program stored in a recording medium ST is timely loaded on a main memory to be executed by a processor. At this point, a drive device such as a CD-ROM drive, a DVD drive, a memory drive or a magneto-optical disk drive is used if necessary. In the case where the recording medium is provided in a server connected through a communication line STD such as a network, the program is read or downloaded from the server through the communication line STD. The program can be supplied in a form operable in any of various OSs, platforms, system environments and network environments.

### II. Architecture of Maintenance Network

In FIG. 2, the network monitor system 11 includes a radio access network access unit 101, a network information collection unit 102, a station data transfer unit 103, a station data creation system access unit 104 and a network information storage unit 151.

The radio access network access unit 101 communicates with the respective devices of the radio access network 1 through the maintenance line CW. For example, in transferring the station data DN of a switching center MMS or a radio network controller RNC, the data is transferred through the radio access network access unit 101.

The network information collection unit 102 collects information from the radio access network 1 and stores the collected information in the network information storage unit 151.

The station data transfer unit 103 directs the radio access network access unit 101 to transfer station data DN created by the station data creation system 12 to a corresponding device of the radio access network 1.

The station data creation system access unit 104 manages communication with the station data creation system 12.

The network information storage unit 151 stores and manages network information D151, that is, various information indicating the situation of the radio access network 1.

The station data creation system 12 includes a statistical information management unit 201, a network situation check unit 203, an optimization control unit 204, an optimization analysis unit 205, an excess bandwidth analysis unit 206, an event information control unit 209, an event information analysis unit 210, a location information analysis unit 211, an OPS access unit 215, a station data creation unit 220, a maintenance terminal access unit 230, a statistical information storage unit 251, a station set information storage unit 253, a threshold value data storage unit 254, a past optimization information storage unit 255 and an event actual information storage unit 256.

The statistical information management unit 201 acquires the network information D151 collected by the network monitor system 11 and organizes it as statistical information D251. The statistical information management unit 201 also activates the network situation check unit 203.

The network situation check unit 203, which is activated by the statistical information management unit 201, analyzes whether or not congestion is caused in the radio access network 1 on the basis of the statistical information D251 and the station set information D253. The network situation check unit 203 activates the optimization control unit 204 on the basis of the analysis result.

The optimization control unit 204, which is activated by the network situation check unit 203, activates the optimization analysis unit 205 by using, as input information, the analysis result obtained by the network situation check unit 203.

The optimization analysis unit 205, which is activated by the optimization control unit 204, deduces an optimum value of setting data, such as an optimum bandwidth value, and activates the excess bandwidth analysis unit 206. It also activates the station data creation unit 220 with an optimum value, such as an optimum value of the bandwidth value (optimum bandwidth value) BS, determined by the excess bandwidth analysis unit 206. Alternatively, when the optimization is impossible, it informs the maintenance terminal 13 through the maintenance terminal access unit 230 of the impossibleness.

The excess bandwidth analysis unit 206, which is activated by the optimization analysis unit 205, analyzes whether or not a bandwidth value used in another virtual channel is usable and determines the optimum bandwidth value BS. The optimization analysis unit 205 is informed of the determined optimum bandwidth value BS.

The event information control unit 209 is activated by the maintenance terminal 13 through the maintenance terminal access unit 230. The event information control unit 209 activates the location information analysis unit 211 for acquiring location information. The event information control unit 209 also activates the event information analysis unit 210, acquires the optimum bandwidth value BS and activates the optimization analysis unit 205.

The event information analysis unit 210, which is activated by the event information control unit 209, obtains setting data such as a bandwidth value (a use bandwidth value) BT employed in the same type of event held in the past on the basis of event actual information D256, deduces an optimum bandwidth value BS and informs the event information control unit 209 of it.

The location information analysis unit 211, which is activated by the event information control unit 209, extracts devices provided close to the location information of a site of the event, builds a device number analyzing order table HJ and informs the event information control unit 209 of it.

The OPS access unit 215 manages communication with the network monitor system 11.

The station data creation unit 220 creates station data DN by, for example, converting data input by a person in charge of maintenance into a format settable for each device of the radio access network 1, namely, each of the switching center MMS, the radio network controllers RNC and the nodes NE. In this embodiment, the station data DN on an optimum bandwidth value BS in particular is created as described above. It is noted that the function of the station data creation unit 220 itself is conventionally known.

The maintenance terminal access unit 230 manages communication with the maintenance terminal 13.

The statistical information storage unit 251 stores and manages statistical information D251, that is, processed information on the network situation of the radio access network 1 obtained from the network monitor system 11.

The station set information storage unit 253 stores and manages station set information D253, that is, a set value of each station set for each device of the radio access network 1. The station set information D253 includes the station data DN. It is noted that the function of the station set information storage unit 253 itself is conventionally known.

The threshold value data storage unit 254 stores and manages threshold value data D254 including a critical threshold value DTG and a safety threshold value DTA.

The past optimization information storage unit 255 stores and manages past optimization information D255, that is, information for managing past optimum bandwidth values BS in correspondence to time and an increasing rate.

The event actual information storage unit 256 stores and manages event actual information D256 including an actual bandwidth value BJ, that is, actual information on a use bandwidth value BT, of each of past events.

The maintenance terminal 13 includes an HMI (Human Machine Interface) 301, an event information management unit 302, a task management unit 303, a station data creation request unit 304, a station data creation system access unit 310 and an event information storage unit 351.

The HMI 301 is a man-machine interface provided between the maintenance terminal 13 and a person in charge of maintenance and is, for example, a keyboard, a mouse, another pointing device, a display device, a touch panel or the like.

The event information management unit 302 stores and manages event information input by a person in charge of maintenance in the event information storage unit 351. Also, the event information management unit 302 deduces location information on the basis of a site of an event.

The task management unit 303 activates the station data creation request unit 304. This function is provided in an OS (Operating System) of the maintenance terminal 13.

The station data creation request unit 304, which is activated by the task management unit 303, passes the event information to the station data creation system 12 and makes a request for creating station data on an optimum bandwidth value BS to be employed in the event.

The station data creation system access unit 310 manages communication with the station data creation system 12.

The event information storage unit 351 stores and manages event information D351 set by the event information management unit 302.

As a characteristic of this embodiment, the maintenance terminal 13 is provided with the event information management unit 302 and the event information storage unit 351.

The aforementioned units can be grouped in accordance with their functions as follows:

The statistical information management unit 201 and the network situation check unit 203 analyze congestion on the basis of the statistical information D251 based on actual operational information periodically collected and the station set information D253 currently set for determining, for example, whether or not congestion can probably be or actually is caused in the radio access network 1. Accordingly, these units can be regarded to belong to a situation checking group.

The optimization control unit 204, the optimization analysis unit 205 and the excess bandwidth analysis unit 206 analyze to determine whether or not there is any surplus station or line correspondingly to a station or line in which congestion is highly probably caused, and determine an optimum value, for example, an optimum bandwidth value BS through further comprehensive analysis. Accordingly, these units can be regarded to belong to an optimum value determining group.

The event information control unit 209, the event information analysis unit 210 and the location information analysis unit 211 manage information on events held in the past and the future, and perform control to determine an optimum value of station data DN in time of holding an event so as to avoid congestion from being caused by the event. Accordingly, these units can be regarded to belong to an event dealing group.

### III. Outline of Processes or Operations

The outline of processes or operations performed for optimizing the station data DN in the mobile communication network system NS having the aforementioned architecture will now be described.

Specifically, the following processes are executed in the maintenance network 2 and in the station data creation system 12 in particular: A process of acquiring actual operational information JJ corresponding to the actual operational history of the mobile communication network system NS; a process of acquiring setting data DNS corresponding to station data DN set for each node provided in the mobile communication network system NS; a process of extracting a node or a channel expected to have increase in traffic and a node or a channel having a margin in traffic on the basis of the actual operational information JJ and the setting data DNS; a process of creating station data DN optimized in consideration of change of traffic to be set for each extracted node; and a process of transferring the created station data DN to the corresponding node for update.

The process of extracting a node or a channel includes a process extracting, as the node or the channel expected to have increase in traffic, a node or a channel containing an item which is included in the actual operational information and of which data exceeds a critical threshold value precedently set with respect to the item; and a process extracting, as the node or the channel having a margin in traffic, one or more nodes or channels that together are capable of absorbing a sum of increase in traffic expected in the node or the channel that has been extracted as a node or a channel expected to have increase in traffic.

Furthermore, in the case where an event is planned to be held in an area where the mobile communication network system NS is provided, task activation time is determined on the basis of the time when the event is held and at least the process of transferring the created station data is executed after the determined task activation time comes.

Alternatively, the following processes are executed in the station data creation system 12: A first process of acquiring actual operational information indicating the actual operational history of the mobile communication network system NS; a second process of acquiring setting data DNS corresponding to station data DN set for each node provided in the mobile communication network system NS; a third process, performed when an actual bandwidth value of a channel of a node included in the actual operational information exceeds a critical bandwidth value obtained based on a set bandwidth value and a critical threshold value set correspondingly to the channel, of extracting such a channel as a target channel and a node including the target channel as a target node; a fourth process of determining, with respect to the target channel, an optimum bandwidth value BS corresponding to a bandwidth value to be set as an optimum value or a difference bandwidth value corresponding to a difference between the optimum bandwidth value BS and the actual bandwidth value; a fifth process of extracting, from channels included in the target node, a channel having a bandwidth value margin, which is obtained from the actual operational information, and the set bandwidth value and a safety threshold value previously set, exceeding the difference bandwidth value as a surplus channel; and a sixth process of creating station data DN to be used for changing and optimizing bandwidth values of the extracted target channel and surplus channel in order to update the node.

In more detail, information on the busy condition of each line in the radio access network 1, such as the IMT-2000 network, namely, the actual operational information indicating the actual operational history, is periodically received by the statistical information management unit 201, information (data) on, for example, use bandwidth values BT out of the received information is organized as the statistical information D251, and the organized statistical information D251 is stored and managed by the statistical information storage unit 251.

The optimization analysis unit 205 analyzes the statistical information D251 managed by the statistical information storage unit 251 and determines an optimum value of the station data DN on the basis of the station set information D253 registered in the station set information storage unit 253. In determining the optimum value of the station data DN, the optimization analysis unit 205 determines an optimum bandwidth value BS corresponding to an optimum use bandwidth on the basis of the maximum bandwidth of each station and the use bandwidth value BT of each line (channel) currently employed. The station data creation unit 220 creates station data DN by using the determined optimum bandwidth value BS and transmits the created station data DN to each node NE or each radio network controller RNC of the radio access network 1 through the network monitor system 11.

In other words, an optimum bandwidth value BS of each station or each line (channel) including the nodes NE and the radio network controllers RNC is obtained on the basis of the station structure and the operational history such as the traffic information of the radio access network 1, and the optimum bandwidth value BS is reflected on a real-time basis as the station data DN of the use bandwidth value BT of the corresponding station.

Although a use bandwidth value is exemplified as the station data DN in this embodiment, the embodiment is applicable to any of various items of the station set information D253 or the station data DN managed as the operational data.

For example, the embodiment is applicable to information or data on a carrier (carrier wave), a sector, an antenna angle, transmission power, a physical line, a logical line, a card or a station structure. Specifically, with respect to any of these items, optimized station data DN of a target station or line is obtained on the basis of actual operational information and station data DN currently actually set, and the thus obtained station data DN can be reflected on the target station or line on a real-time basis.

Furthermore, with respect to the traffic information that cannot be monitored by a person in charge of maintenance, the statistical information D251 of each station is managed in a centralized manner by the statistical information storage unit 251, so as to obtain optimum station data DN of each node NE or line on a real-time basis on the basis of the traffic information of nodes NE present adjacently or around, and the thus obtained station data DN can be fed back to the corresponding station.

### IV. EXAMPLES

Specific examples of processes performed for reducing congestion in a network will now be described on the assumption that the station data DN is a “bandwidth value”.

Specifically, in FIG. 1, it is assumed that the network of the node NE(0) working under the radio network controller RNC(0) is congested and hence a mobile terminal provided under the node NE(0) cannot make an access to a mobile terminal provided under the node NE(1). Under these conditions, a process of reducing the congestion of the network by changing allocation of network resources by changing station data DN is performed.

Since various items of the station data DN of the radio network controllers RNC and the nodes NE included in the radio access network 1 can be changed on a real-time basis by the maintenance network 2 of this embodiment, it goes without saying that any of other items of the station data DN apart from the “bandwidth value” may be employed for the process.

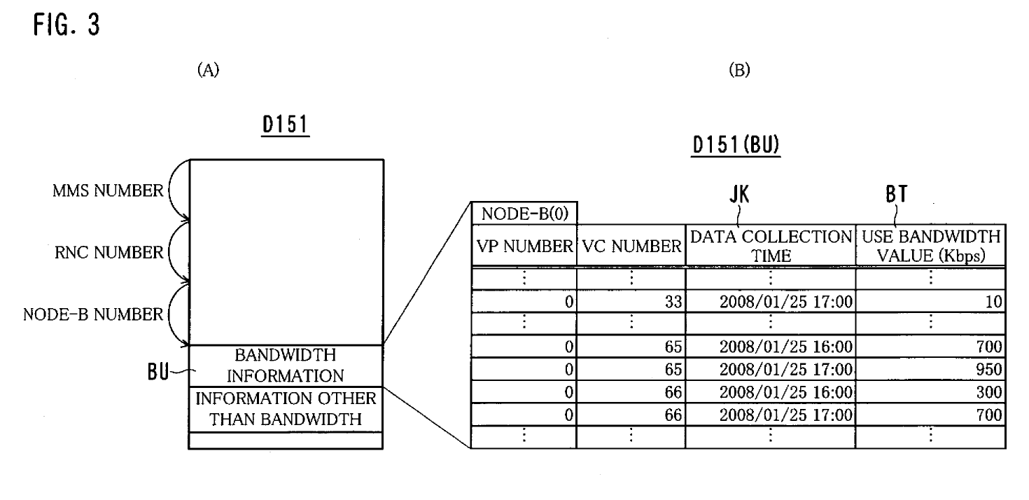

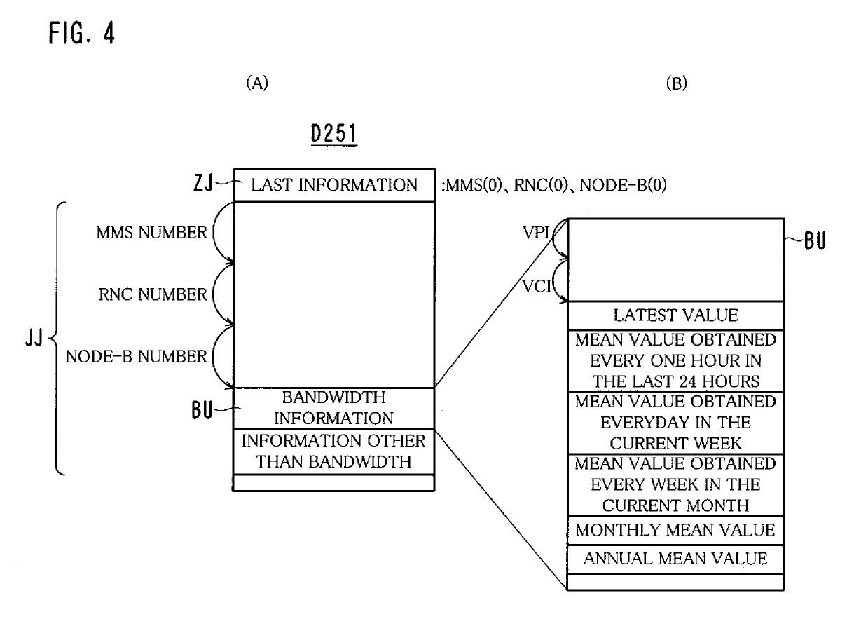

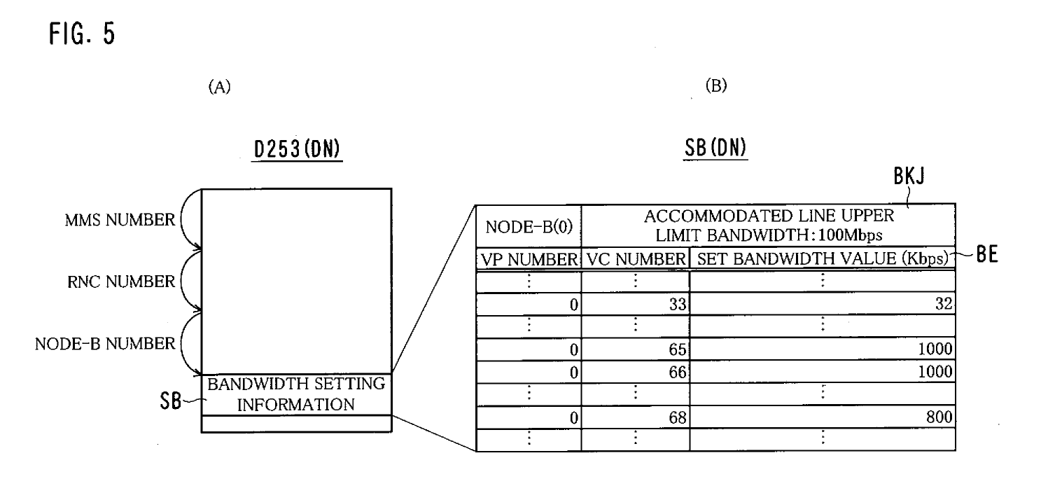

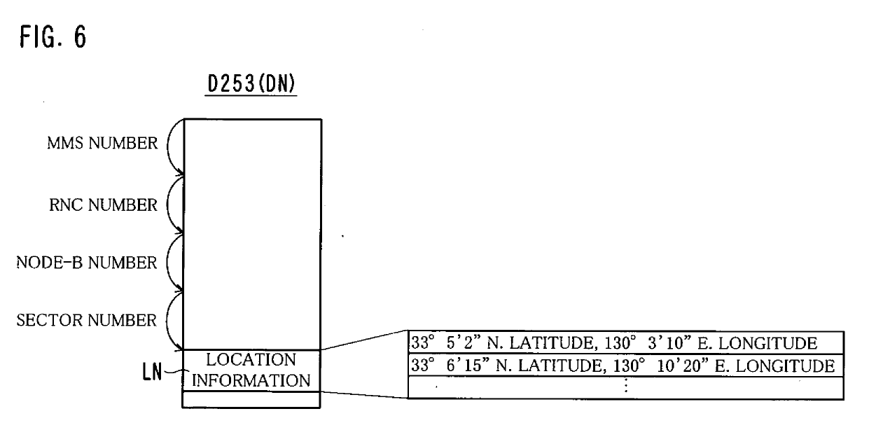

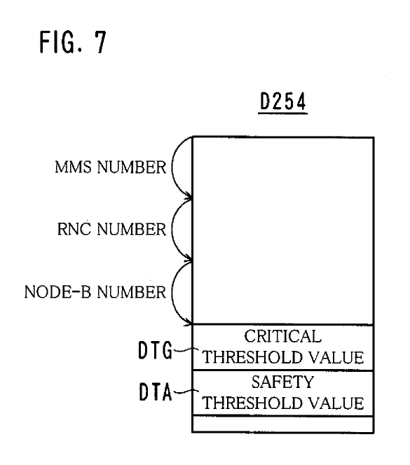

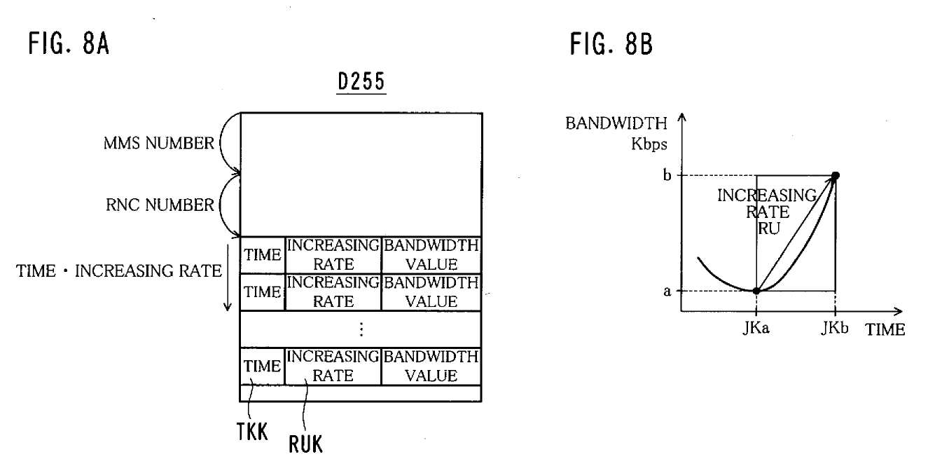

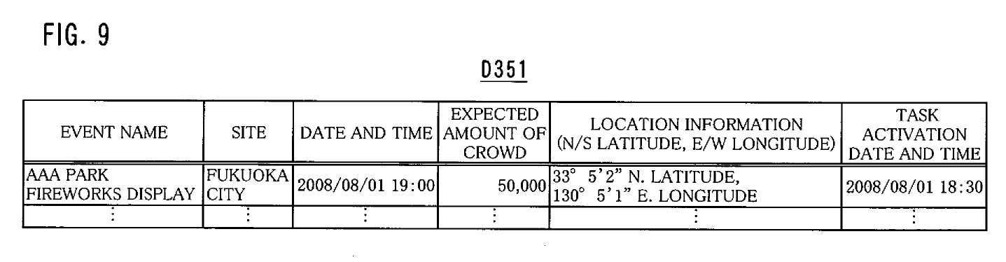

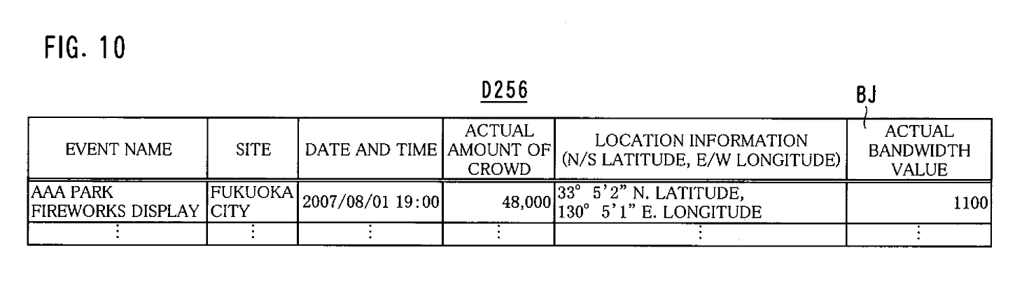

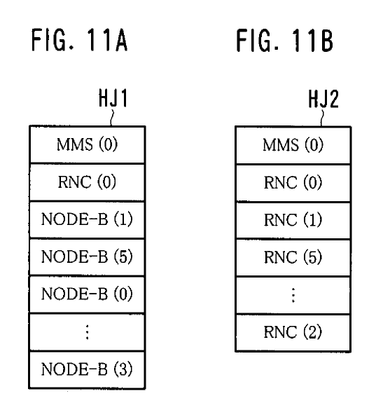

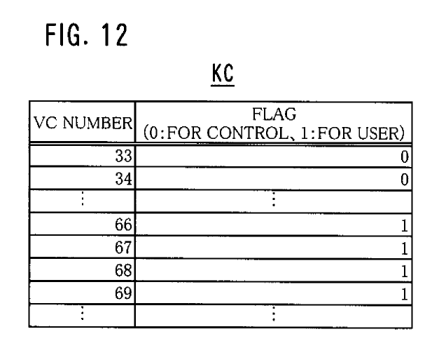

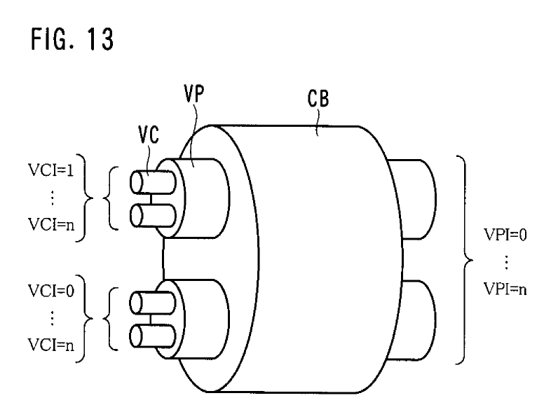

FIG. 3 is a diagram illustrating examples of the network information D151 stored in the network information storage unit 151, FIG. 4 is a diagram illustrating examples of the statistical information D251 stored in the statistical information storage unit 251, FIG. 5 is a diagram illustrating examples of the station set information D253 on bandwidth values stored in the station set information storage unit 253, FIG. 6 is a diagram illustrating examples of the station set information D253 on location information LN stored in the station set information storage unit 253, FIG. 7 is a diagram illustrating examples of the threshold value data D254 stored in the threshold value data storage unit 254, FIGS. 8A and 8B are diagrams illustrating examples of the past optimization information D255 stored in the past optimization information storage unit 255, FIG. 9 is a diagram illustrating an example of the event information D351 stored in the event information storage unit 351, FIG. 10 is a diagram illustrating an example of the event actual information D256 stored in the event actual information storage unit 256, FIGS. 11A and 11B are diagrams illustrating examples of a device number analyzing order table HJ, FIG. 12 is a diagram illustrating examples of virtual channel management information KC and FIG. 13 is a diagram explaining a virtual path VP and a virtual channel VC.

### [1. Collection of Actual Operational Information of Radio Access Network]

First, the network monitor system 11 periodically collects information indicating the situation of the radio access network 1 by using an existing function and stores the collected information as the network information D151 in the network information storage unit 151 for a predetermined period of time. For example, the network monitor system 11 collects the information every one hour. The information includes a use bandwidth value BT of each node NE of each radio network controller RNC.

In (A) of FIG. 3, the network information D151 includes information on situations of all the switching centers MMS, all the radio network controllers RNC and all the nodes NE. In other words, a number of each of the switching centers MMS, the radio network controllers RNC and the nodes NE is specified so as to successively specify all the nodes NE, and the information on the situation of each specified node is recorded. In (A) of FIG. 3, the network information D151 includes bandwidth information BU. An example of information other than the bandwidth information BU is “number of incoming/outgoing calls/communications”.

As illustrated in (B) of FIG. 3, as the bandwidth information BU, a measured use bandwidth BT and measuring time JK are recorded in correspondence to a VP number, that is, a number of a virtual path (VP) in a line, and a VC number, that is, a number of a virtual channel (VC) of the corresponding VP number.

As is understood from (B) of FIG. 3, with respect to the VC numbers “65” and “66” of the VP number “0”, the use bandwidth values BT were measured at “1600 hours on Jan. 25, 2008” and “1700 hours on Jan. 25, 2008”, and the use bandwidth values TB were “700”, “950”, “300” and “700”.

It is noted that a virtual path VP or a virtual channel VC is a line logically allocated in one physical cable CB as illustrated in FIG. 13. In general, a plurality of virtual paths VP are allocated to one physical cable CB and a plurality of virtual channels VC are allocated to one virtual path VP. Thus, multiplex communication can be performed by providing one physical cable. A physical cable CB is provided between, for example, a radio network controller RNC and a node NE.

It is noted that a virtual path VP or a virtual channel VC may be herein sometimes mentioned by using merely a VP number (VPI) or a VC number (VCI).

In the station data creation system 12, the statistical information management unit 201 receives the network information D151 from the network monitor system 11 and organizes the received information as the statistical information D251.

Referring to (A) of FIG. 4, the statistical information D251 includes last information ZJ corresponding to information on a node NE(0) collected in the last time of collection and actual operational information JJ on a node NE(1) collected this time of collection. The actual operational information JJ includes the bandwidth information BU.

Referring to (B) of FIG. 4, the bandwidth information BU of the statistical information D251 includes, correspondingly to each VP number and each VC number, the latest value of the bandwidth information BU, a mean value obtained every one hour in the last 24 hours, a mean value obtained everyday in the current week, a mean value obtained every week in the current month, an annual mean value and the like.

In collecting the actual operational information JJ, the statistical information management unit 201 extracts the last information ZJ from the statistical information D251. For example, in the case where “MMS(0), RNC(0) and NE(0)” is set in the last information ZJ, a next node to the lowest station among the set stations, which is the node NE(0) in this case, namely, the node NE(1) next to the node NE(0), is a current target for collecting the network information D151 from the network monitor system 11.

The thus extracted information of the target station, that is, “MMS(0), RNC(0) and NE(1)”, is set as the last information ZJ of the statistical information D251.

Accordingly, if, for example, “MMS(0), RNC(0) and NE(n)” is set as the last information ZJ, the node NE(n) is a node NE having the final number, and hence, it means that the information of all the nodes NE working under MMS(0) and RNC(0) has been collected. Therefore, one of nodes NE working under MMS(0) and RNC(1) is selected next as a current target for collecting the information.

It is noted that a use bandwidth value BT listed in (B) of FIG. 3 corresponds to the latest use bandwidth value BT of MMS(0), RNC(0) and NE(0).

When the target station for collecting the information is extracted, the statistical information management unit 201 activates the OPS access unit 215 by using the target station, that is, “MMS(0), RNC(0) and NE(0)” in this case, as input information, for communicating with the station data creation system access unit 104. The station data creation system access unit 104 activates the network information collection unit 102.

The network information collection unit 102 extracts network information on the node NE(0) by retrieving the network information D151 with the input information “MMS(0), RNC(0) and NE(0)” used as an index. The thus extracted network information is transmitted to the statistical information management unit 201 through the communication between the station data creation system access unit 104 and the OPS access unit 215.

In this manner, the actual operational information JJ of the radio access network 1 is acquired.

### [2. Situation Check of Radio Access Network]

The statistical information management unit 201 performs necessary operations by using the network information collected with respect to MMS(0), RNC(0) and NE(0), calculates information on a data item managed as the statistical information D251, and updates the statistical information D251 by writing the calculated information in the statistical information storage unit 251.

Next, the statistical information management unit 201 activates the network situation check unit 203 by using “MMS(0), RNC(0) and NE(0)” and a target item of the situation check (that is, a check target item) as input information.

Although the check target item is herein a “bandwidth value”, any of items managed by both the network information D151 collected by the network monitor system 11 and the station set information D253 can be selected as the check target item.

The network situation check unit 203 extracts, from the statistical information D251, a “latest value” of the bandwidth value of “MMS(0), RNC(0) and NE(0)”. Furthermore, the network situation check unit 203 extracts, from the station set information D253, a set bandwidth value BE set as the station data DN of “MMS(0), RNC(0) and NE(0)”.

In (A) of FIG. 5, the set information of each of the radio network controllers RNC and each of the nodes NE is recorded as the station set information D253. This exemplified case of (A) of FIG. 5 illustrates bandwidth set information SB.

It is noted that the station set information D253 corresponds to setting data of this embodiment, and the bandwidth set information SB or the set bandwidth value BE is data included in setting data DNS and related to a bandwidth value.

In (B) of FIG. 5, set bandwidth values BE are recorded as the bandwidth set information SB correspondingly to each VP number and each VC number. For example, with respect to the VC numbers “65” and “66” of the VP number “0”, the set bandwidth values BE are respectively “1000” and “1000” (in kbps).

Moreover, as the bandwidth set information SB, a node number and an accommodated line upper limit bandwidth BKJ are recorded. The accommodated line upper limit bandwidth BKJ corresponds to an upper limit of the sum of set bandwidth values BE of lines (virtual paths and virtual channels) accommodated in each node NE.

The network situation check unit 203 further extracts, from the threshold value data storage unit 254, threshold value data D254 of “MMS(0), RNC(0) and NE(0)”. The threshold value data D254 includes a critical threshold value DTG and a safety threshold value DTA.

The critical threshold value DTG is used as follows: When a use bandwidth value BT corresponding to the actual operational information JJ exceeds this critical threshold value DTG, a node NE or a virtual channel VC containing this item is extracted as a node NE or a virtual channel VC expected to have increase in traffic.

Herein, the critical threshold value DTG is not indicated by a bandwidth value corresponding to the limit (namely, a critical bandwidth value) but indicated by a ratio (percentage) to a set bandwidth value BE. Specifically, the critical threshold value DTG is “90”% in the exemplified case. Accordingly, when a set bandwidth value BE is, for example, “1000”, the critical bandwidth value is 1000×0.9, namely, “900”.

It is noted that the threshold value data D254 is set by a person in charge of maintenance when the corresponding station is established.

Accordingly, when a use bandwidth value BT (an actual bandwidth value) of a virtual channel VC of a node NE included in the actual operational information JJ exceeds a critical bandwidth value obtained based on a set bandwidth value BE and a critical threshold value DTG set correspondingly to the virtual channel VC, this virtual channel VC is extracted as a target channel. Also, a node NE including the target channel is extracted as a target node.

More specifically, three kinds of information extracted by the network situation check unit 203, that is, the “latest value” of the bandwidth value of the actual operational information JJ extracted from the statistical information D251, the “set bandwidth value BE” extracted from the station set information D253 and the “critical threshold value DTG” extracted from the threshold value data D254, are used to check whether or not the “latest value” exceeds the “critical threshold value DTG” set correspondingly to the “set bandwidth value BE”.

For example, with respect to the VC numbers “65” and “66” of the VP number “0”, the “latest numbers” are “950” and “700” (see (B) of FIG. 3) and the “set bandwidth values BE” are “1000” and “1000” (see (B) of FIG. 5), and therefore, the critical bandwidth values are both “900” when the “critical threshold value DTG” is “90%”. Accordingly, with respect to the VC number “65”, the latest number of the use bandwidth value BT, that is, “950”, exceeds the critical threshold value DTG, and with respect to the VC number “66”, the latest number does not exceed the critical threshold value DTG.

The network situation check unit 203 checks the situation in this manner, and when it is found as a result of the situation check that a latest number does not exceed a critical threshold value, it is determined that there is “no need of optimization”, and the network situation check unit 203 terminates the situation check process and informs the statistical information management unit 201 of “no need of optimization”. In this case, the statistical information management unit 201 starts collecting the actual operational information JJ of a next device (station) of the radio access network 1.

When a latest number is found to exceed a critical threshold value as a result of the situation check, it is determined that there is “need of optimization”, and the optimization control unit 204 is activated by using, as input information, the information corresponding to the virtual channel VC whose latest number has been found to exceed the critical threshold value, and its “latest number”, “set bandwidth value BE” and “critical threshold value DTG”.

Accordingly, in this exemplified case, the VP number “0”, the VC number “65”, “950”, “1000” and “90” are used as the input information.

### [3. Analysis of Optimum Value of Station Data]

The optimization control unit 204 activates the optimization analysis unit 205 by using, as input information, a virtual channel VC found to have a need of optimization, the bandwidth information BU on the virtual channel VC (see (B) of FIG. 4), device information corresponding to information for specifying a switching center MMS, a radio network controller RNC and a node NE under which the virtual channel VC is provided, and a check target item.

The optimization analysis unit 205 obtains, on the basis of the actual operational information JJ, an increasing rate RU of the bandwidth value calculated based on a lowest value a and a subsequent highest value b of the latest use bandwidth values BT (actual bandwidth values) of the target channel and elapse time TK elapsed between these lowest and highest values, and extracts, from the actual operational information JJ obtained previously, an increasing rate RU and elapse time TK the most similar to the obtained increasing rate RU and elapse time TK. The maximum bandwidth value corresponding to the thus extracted increasing rate RU and elapse time TK is used as an optimum bandwidth value BS.

Specifically, the optimization analysis unit 205 acquires, on the basis of MMS(0), RNC(0) and NE(0), the VP number “0”, the VC number “65” and the bandwidth information BU input thereto, mean values of every hour in the last 24 hours, extracts a lowest value (a) in the latest use bandwidth values BT of the VC number “65” and time JKa corresponding to the lowest value (a), and calculates an increasing rate RU of the use bandwidth values BT on the basis of the lowest value (a) and the latest value (b) of the use bandwidth values BT. More specifically, the increasing rate RU is obtained as follows (see FIG. 8B):

RU=(b−a)/a

Furthermore, elapse time TK is calculated on the basis of time JKb corresponding to the latest value (b) and the time JKa corresponding to the lowest value (a) of the use bandwidth values BT of the VC number “65”.

The optimization control unit 204 retrieves the past optimization information D255 by using the calculated increasing rate RU and elapse time TK as input information, and a bandwidth value having the most similar increasing rate RU and elapse time TK is extracted as optimization information. The extracted optimization information is used as a virtual optimum bandwidth value BSK.

The virtual optimum bandwidth value BSK is an optimum bandwidth value BS preferred for the node NE or virtual channel VC expected to have increase in traffic, and in the case where there is a node NE or a virtual channel VC capable of absorbing the virtual optimum bandwidth value BSK, the virtual optimum bandwidth value BSK is used as an optimum bandwidth value BS.

As illustrated in FIG. 8A, elapse time TKK and an increasing rate RUK obtained when a use bandwidth value BT increased in the past and a bandwidth value having been set at that point are recorded as the past optimization information D255 as a database. An optimum bandwidth value BS is determined on the basis of such actual operational information JJ of the past.

It is assumed in this embodiment that the extracted optimization information of the bandwidth value is “1140”, and this value is used as the virtual optimum bandwidth value BSK later. Any of other various methods or statistical techniques may be employed for determining the virtual optimum bandwidth value BSK.

Furthermore, a difference bandwidth value BN corresponding to a difference between the set bandwidth value BE currently set and the virtual optimum bandwidth value BSK is obtained. In this exemplified case, a difference between the set bandwidth value BE, “1000”, and the virtual optimum bandwidth value BSK, “1140”, is obtained as 1140−1000=140, and “140” is used as the difference bandwidth value BN.

Alternatively, with respect to the past optimization information D255, the increasing rate RU may be a rate of increase obtained during the elapse time TKK, or a rate of increase per unit time during the elapse time TKK.

### [4. Check Whether Optimum Value is Settable]

The optimization analysis unit 205 extracts the accommodated line upper limit bandwidth BKJ by retrieving the station set information D253 with MMS(0), RNC(0) and NE(0) used as an index. Furthermore, the optimization analysis unit 205 calculates a total bandwidth value BGC, that is, a sum (ALL-VC) of set bandwidth values BE set correspondingly to all the virtual channels VC provided under the VP number “0”.

In calculating the total bandwidth value BGC, however, with respect to the virtual channel VC with the VC number “65”, the virtual optimum bandwidth value BSK, “1140”, is used in the calculation as the set bandwidth value BE.

The calculated total bandwidth value BGC is compared with the accommodated line upper limit bandwidth BKJ. When the total bandwidth value BGC exceeds the accommodated line upper limit bandwidth BKJ, the event information control unit 209 is informed that “NE(0) cannot secure a bandwidth value”. When the total bandwidth value BGC does not exceed the accommodated line upper limit bandwidth BKJ, the optimization analysis unit 205 extracts a maximum bandwidth of accommodated lines of the radio network controller RNC(0) on the basis of the station set information D253.

Furthermore, the optimization analysis unit 205 calculates, on the basis of the station set information D253, the total bandwidth values BGC of all the nodes NE working under the radio network controller RNC(0) and calculates a total bandwidth value BGN corresponding to a sum (ALL-NE) of the total bandwidth values of all the nodes NE.

In the calculation of the total bandwidth value BGN, however, with respect to the total bandwidth value BGC of the node NE(0), a value obtained by using the virtual optimum bandwidth value BSK, “1140”, as the set bandwidth value BE of the virtual channel VC with the VC number “65” is used.

The thus calculated total bandwidth value BGN is compared with the maximum bandwidth of accommodated lines of the radio network controller RNC(0). When the total bandwidth value BGN exceeds the maximum bandwidth of accommodated lines of the radio network controller RNC(0), the event information control unit 209 is informed that “RNC(0) cannot secure a bandwidth value”.

In the case where the accommodated line upper limit bandwidth BKJ and the maximum bandwidth of accommodated lines of the radio network controller RNC(0) respectively do not exceed the total bandwidth values BGC and BGN, the optimization analysis unit 205 activates the excess bandwidth analysis unit 206 by using, as input information, “1140” corresponding to the virtual optimum bandwidth value BSK of the VC number “65”, MMS(0), RNC(0), the VP number “0” and the VC number “65”.

### [5. Check of Surplus Device]

The excess bandwidth analysis unit 206 extracts the bandwidth set information SB (see FIG. 5) of each virtual channel VC of the VP number “0” on the basis of the station set information D253 by using, as input information, “1140”, that is, the virtual optimum bandwidth value BSK of the VC number “65”, MMS(0), RNC(0) and the VP number “0”.

Next, the excess bandwidth analysis unit 206 extracts a latest use bandwidth value BT (see FIGS. 3 and 4) of each virtual channel VC other than the virtual channel VC with the VC number “65” on the basis of the statistical information D251 by using, as input information, MMS(0), RNC(0) and the VP number “0”.

Furthermore, the excess bandwidth analysis unit 206 extracts, from the threshold value data D254, a safety threshold value DTA of MMS(0) and RNC(0).

At this point, a safety threshold value DTA is a value as follows: When a latest use bandwidth value BT extracted from the statistical information is increased by an increment corresponding to the safety threshold value DTA, congestion can be more probably avoided.

Herein, the safety threshold value DTA is indicated by a ratio (percentage) to the use bandwidth value BT. Specifically, the safety threshold value DTA is “20”% in this exemplified case. Accordingly, when the use bandwidth value BT is, for example, “700”, the increment is 700×0.2=“140”, and it can be said that congestion can be highly probably avoided by setting the set bandwidth value to “840” (=700+140).

The three kinds of extracted information, namely, the bandwidth set information SB of each virtual channel VC extracted from the station set information D253, the latest use bandwidth value BT of each virtual channel VC extracted from the statistical information D251 and the safety threshold value DTA, are used for calculating an excess bandwidth BY of each virtual channel VC.

Specifically, when the three kinds of information are assumed as follows:

(1) “1000”, that is, the bandwidth set information SB of the VC number “66” extracted from the station set information D253;

(2) “700”, that is, the latest use bandwidth value BT of the VC number “66” extracted from the statistical information D251; and

(3) “20”%, that is, the safety threshold value DTA, the excess bandwidth BY of the VC number “66” is obtained as follows:

1000−(700+700×0.2)=160 [kbps]

Furthermore, with respect to the VC number “65”, the virtual optimum bandwidth value BSK is “1140”, the set bandwidth value BE is “1000” and the difference bandwidth value BN is “140”. Accordingly, in order to set “1140”, that is, the virtual optimum bandwidth value BSK, as the set bandwidth value BE of the VC number “65”, it is necessary to eliminate the difference bandwidth value BN of “140” from the set bandwidth value BE of another virtual channel VC.

Since the excess bandwidth BY of the VC number “66” is “160” in this embodiment, when this excess bandwidth BY is reduced to replenish the bandwidth value of the VC number “65”, the set bandwidth value BE of the VC number “65” can be set to “1140”.

Accordingly, with respect to the VC number “65”, the virtual optimum bandwidth value BSK of “1140” can be used as the optimum bandwidth value BS.

In this case, the set bandwidth value BE of the VC number “66” is as follows:

1000−140=860 [kbps]

Eventually, “1140” and “860” are respectively set as the set bandwidth values BE of the virtual channel with the VC number “65” and the VP number “0” in MMS(0), RNC(0) and NE(0) and of the virtual channel with the VC number “66” and the VP number “0” in MMS(0), RNC(0) and NE(0).

The excess bandwidth analysis unit 206 informs the optimization analysis unit 205 of the obtained set bandwidth value BE. The optimization analysis unit 205 activates the station data creation unit 220 by using the set bandwidth value BE as input information.

If the difference bandwidth value BN of the VC number “65” cannot be secured by merely the excess bandwidth BY of the VC number “66”, excess bandwidths BY of the virtual channels are successively obtained from a virtual channel with the next VC number “67” to a virtual channel with the final VC number.

In this case, however, a virtual channel VC is selected from user channels alone but is not obtained from control channels. In order to distinguish a user channel from a control channel, virtual channel management information KC illustrated in FIG. 12 is used.

In the virtual channel management information KC of FIG. 12, a VC number with a flag “0” is a control channel and a VC number with a flag “1” is a user channel. Accordingly, the optimization for avoiding the congestion is performed by using merely VC numbers with the flag “1”.

Moreover, if a sum of the excess bandwidths BY of all the virtual channels VC of the current node NE is not sufficient, the excess bandwidth analysis unit 206 determines that it is “insufficient excess” and informs the optimization analysis unit 205 of it.

The optimization analysis unit 205 transmits, to the maintenance terminal 13 through the maintenance terminal access unit 230, information corresponding to the optimum bandwidth value BS of the VC number “65”, namely, MMS(0), RNC(0), NE(0), the VP number “0”, the VC number “65” and “1140”.

### [6. Secure of Optimum Bandwidth Value (Part 1)]

The event information control unit 209 having been informed that “NE(0) cannot secure a bandwidth value” by the optimization analysis unit 205 extracts, on the basis of a device number analyzing order table HJ1 illustrated in FIG. 11A, a next device of MMS(0), RNC(0) and NE(0), that is, MMS(0), RNC(0) and NE(1), and activates the optimization analysis unit 205 by using, as input information, the extracted next device with the virtual optimum bandwidth value BSK, “1140”.

It is noted that devices are registered in the device number analyzing order table HJ1 in the ascending order of direct distance from the target node NE.

Similarly, the event information control unit 209 having been informed that “RNC(0) cannot secure a bandwidth value” by the optimization analysis unit 205 extracts, on the basis of a device number analyzing order table HJ2 illustrated in FIG. 11B, a next device of MMS(0) and RNC(0), that is, MMS(0) and RNC(1), and activates the optimization analysis unit 205 by using, as input information, the extracted next device with the virtual optimum bandwidth value BSK of “1140”.

In this manner, when “a bandwidth value cannot be secured” although it has been checked whether or not an optimum value is settable until a bandwidth value can be secured in the current node NE or in all the nodes NE registered in the device number analyzing order table HJ, the event information control unit 209 informs the maintenance terminal 13 of “event information” and “failure in securing a bandwidth” through the maintenance terminal access unit 230.

### [7. Creation of Station Data]

The station date creation unit 220 having been activated by the optimization analysis unit 205 creates station data DN through an existing process. The created station data DN is transmitted, through an existing process, from the OPS access unit 215 to the station data creation system access unit 104 of the network monitor system 11, and is further transmitted to the target device, i.e., the node NE(0) corresponding to the target node in this case, through the station data transfer unit 103 and the radio access network access unit 101. The node NE(0) receives the station data DN and updates the station data DN therein by using the received data.

As described so far, the actual operational information JJ of the radio access network 1 is collected on a real-time basis to be compared with station data DN currently set, and a node or a channel (a virtual channel) expected to have increase in traffic and a node or a channel (a virtual channel) having a margin in traffic are extracted on the basis of the actual operational information JJ and the station data DN, so that station data DN optimized in consideration of change of traffic can be created.

In this manner, optimum station data DN can be automatically created on the basis of notice and traffic information supplied from the network of the radio access network 1, and a file of the created station data DN can be fed back to the radio access network 1 on a real-time basis. Accordingly, the occurrence of congestion caused by an unexpected or temporary factor can be avoided and the occurrence of congestion can be prevented as much as possible in the radio access network 1.

Moreover, in accordance with the increase of the number of subscribers and the communication traffic in the radio access network 1, the number of lines accommodated in each node NE can be increased and a use bandwidth value BT can be changed on a real-time basis. Therefore, service with always stable line quality can be provided.

Furthermore, it is not necessary for a person in charge of maintenance to perform an operation for changing, with respect to nodes NE in number over tens of thousands, the number of lines accommodated in each node NE and a set bandwidth value BE through the maintenance terminal 13. Therefore, station data DN can be accurately and rapidly set or updated, resulting in reducing the load of the person in charge of maintenance.

In addition, as described above, when the optimization process is not automatically performed in the maintenance network 2 but a screen for selecting the process is appropriately displayed on a display screen of the display device, not only data is fixedly set through the automatic setting but also data can be flexibly selected manually by a person in charge of maintenance. In the selection screen used in such a case, for example, a plurality of data within an optimization range may be displayed.

### [8. Response to Event]

Next, optimization of station data DN performed when an event is held will be described. It is herein assumed that a fireworks display is held as the event.

When an event such as a fireworks display is held, a large number of people are concentrated in one area, and the lines become too busy to get through on cellular phones. When the event is held, however, information on the site and the date and time of the event and an expected amount of crowd can be acquired beforehand. Accordingly, the station data DN of related devices can be changed in advance by inputting such known information of the event, so as to reduce the occurrence of congestion.

For example, in accordance with the site of the event, a target device in which the station data DN is to be changed is determined. Also, a set bandwidth value BE to be changed is determined on the basis of the expected amount of crowd. Furthermore, the update date and time of the station data DN is determined on the basis of the date and time of the event.

Also in the following exemplified case, it is assumed that a set bandwidth value BE of a node NE provided under MMS(0) and RNC(0) is changed.

### [9. Setting of Event Information and Request for Station Data Creation]

A person in charge of maintenance inputs, through the maintenance terminal 13, event information such as the name of the event, the starting date and time, the finishing date and time, the site (the address), the expected amount of crowd and station data creation date and time.

The HMI 301 of the maintenance terminal 13 activates the event information management unit 302 by using the input event information as input information. The event information management unit 302 obtains location information (the north latitude/the south latitude/the east longitude/the west longitude) of the site of the event from the information on the site. The location information of the site of the event can be obtained based on the address information by, for example, activating existing application software.

The thus obtained location information and the event information are recorded as event information D351 (see FIG. 9).

In FIG. 9, the event information D351 includes items such as the name of the event, the site (place), the date and time (the starting date and time), the expected amount of crowd, the location information, and task activation date and time (task activation time).

Furthermore, the event information management unit 302 activates the task management unit 303 by using, as input information, “the task activation date and time=the station data creation date and time” and “a task activation program=the station data creation request unit 304”. It is noted that the task management unit 303 is a function provided in the OS.

The task activation date and time is preferably set to time earlier by 1 hour or 30 minutes than the starting date and time of the event and hence is set in consideration of the starting date and time of the event when the person in charge of maintenance inputs the station data creation date and time.

When the task activation date and time recorded in the event information D351 comes, the task management unit 303 activates the station data creation request unit 304. The station data creation request unit 304 retrieves the event information D351 by using “the station data creation date and time” as a key so as to collect information on a request for station data creation (See FIG. 9).

The station data creation request unit 304 activates, by using the collected information as input information, the event information control unit 209 through the station data creation system access unit 310 and the maintenance terminal access unit 230.

### [10. Deduction of Optimum Bandwidth Value]

The event information control unit 209 activates the location information analysis unit 211 by using the location information (the north latitude/the south latitude/the east longitude/the west longitude) of the site of the event as input information. The location information analysis unit 211 compares respective location information LN (the north latitude/the south latitude/the east longitude/the west longitude) included in the station set information D253 of FIG. 6, builds a device number analyzing order table HJ (see FIGS. 11A and 11B) in which devices (nodes NE) are registered in the ascending order of distance from the location information of the site of the event, and sends it back to the event information control unit 209. It is noted that the nodes NE registered in the device number analyzing order table HJ are nodes NE working under merely one radio network controller RNC.

Next, the event information control unit 209 activates the event information analysis unit 210 by using the name of the event and the expected amount of crowd as input information. The event information control unit 209 retrieves event actual information D256 of FIG. 10 by using the name of the event as a key, so as to extract an actual bandwidth value BJ, that is, a set bandwidth value employed in the same type of event. It is noted that the actual bandwidth value BJ is the maximum value of set bandwidth values BE set in the event. In this exemplified case, the actual bandwidth value BJ is “1100”.

The event actual information D256 is set by a person in charge of maintenance on the basis of actual values employed in events held in the past.

Next, the expected amount of crowd of this event recorded in the event information D351 is compared with actual crowd information of the past event recorded in the event actual information D256, so as to calculate a ratio (a difference ratio) of the expected amount of crowd to the actual crowd information (actual amount of crowd). The calculated difference ratio is stored in, for example, a memory of the event information analysis unit 210.

In the exemplified case illustrated in FIGS. 9 and 10, since the expected amount of crowd is “50000” and the actual crowd information (actual amount of crowd) is “48000”, the difference ratio is 103% (=100×50000/48000).

Then, an optimum bandwidth value BS is obtained by correcting the extracted actual bandwidth value BJ by using the difference ratio. In this case, since the actual bandwidth value BJ is “1100” and the difference ratio is 103%, the optimum bandwidth value BS is 1133 (=1100×1.03).

The optimum bandwidth value BS of “1133” is sent back to the event information control unit 209. If any event of the same type cannot be detected, actual crowd information (actual amount of crowd) closest to the expected amount of crowd is extracted, based on which the difference ratio is obtained for correction, so as to obtain the optimum bandwidth value BS.

### [11. Secure of Optimum Bandwidth Value (Part 2)]

The event information control unit 209 extracts, from the device number analyzing order table HJ, device information close to the location information of the site of the event, and activates the optimization analysis unit 205 by using, as input information, this device information and the optimum bandwidth value BS of “1133”. Thereafter, the processes described in the aforementioned sections from [4. Check whether Optimum Value is Settable] to [7. Creation of Station Data] are executed, and the process is terminated.

The optimization analysis unit 205 activated by the event information control unit 209 informs the event information control unit 209 that “a bandwidth value cannot be secured” when it determines that “a bandwidth value cannot be secured” as described in the section [4. Check whether Optimum Value is Settable]. The event information control unit 209 having been informed that “a bandwidth cannot be secured” extracts, from the device number analyzing order table HJ, a node NE next to the current node NE, and activates the optimization analysis unit 205 by using, as input information, the extracted next node and the optimum bandwidth value BS of “1133”.

Similarly, when the event information control unit 209 is informed by the optimization analysis unit 205 that, for example, “RNC(0) cannot secure a bandwidth value”, the event information control unit 209 extracts RNC(1) next to RNC(0) from the device number analyzing order table HJ, and activates the optimization analysis unit 205 by using, as input information, the extracted RNC(1) and the optimum bandwidth value BS of “1133”.

In this manner, when “a bandwidth value cannot be secured” although it has been checked whether an optimum value can be set until a necessary bandwidth value can be secured in the current node NE or with respect to all the nodes NE registered in the device number analyzing order table HJ, the event information control unit 209 informs the maintenance terminal 13 of “event information” and “failure in securing a bandwidth”.

### [Description Referring to Flowcharts]

Next, the processes or operations performed for optimizing station data DN in the station data creation system 12 will be described with reference to flowcharts.

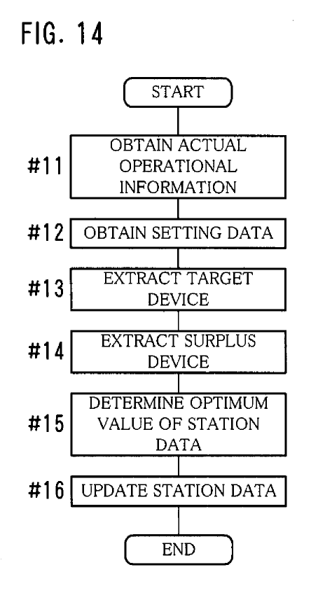

FIG. 14 is a flowchart illustrating the rough flow of the optimization process for station data performed in the station data creation system 12.

In FIG. 14, the actual operational information JJ indicating an actual operational history of the radio access network 1 is acquired (#11), and setting data DNS corresponding to station data DN set for each node of the radio access network 1 is acquired (#12).

On the basis of the actual operational information JJ and the setting data DNS, a target device, namely, a node or channel expected to have increase in traffic, is extracted (#13), and a surplus device, namely, a node or channel having a margin in traffic, is extracted (#14).

With respect to the extracted target device and surplus device, station data DN optimized in consideration of change of traffic is created (#15) and the created station data DN is transferred to the respective devices for update (#16).

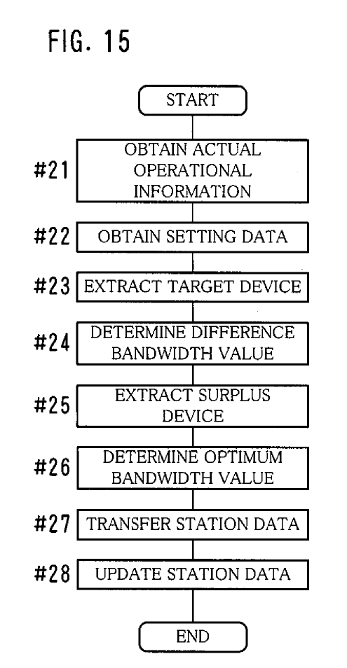

FIG. 15 is a flowchart illustrating the rough flow of the optimization process for a set bandwidth value BE performed in the station data creation system 12.

In FIG. 15, actual operational information JJ indicating an actual operational history of the radio access network 1 is acquired (#21), and setting data DNS corresponding to station data DN set for each node of the radio access network 1 is acquired (#22).

When an actual bandwidth value BJ of a channel of a node included in the actual operational information JJ exceeds a critical bandwidth value obtained from a set bandwidth value BE and a critical threshold value DTG set correspondingly to the channel, the channel is extracted as a target channel and a node including the target channel is extracted as a target node (#23).

With respect to the target channel, an optimum bandwidth value BS, that is, a bandwidth value to be set as an optimum value, or a difference bandwidth value BN, that is, a difference between the optimum bandwidth value BS and the set bandwidth value BE, is determined (#24).

From channels included in the target node, a channel having a margin bandwidth value, which is obtained from the actual operational information JJ, and the set bandwidth value BE and a safety threshold value DTA previously set, exceeding the difference bandwidth value BN is extracted as a surplus channel (#25).

Station data DN used for optimization by changing the bandwidth values of the extracted target channel and surplus channel is created (#26). The created station data DN is transferred to the respective devices (#27) for update (#28).

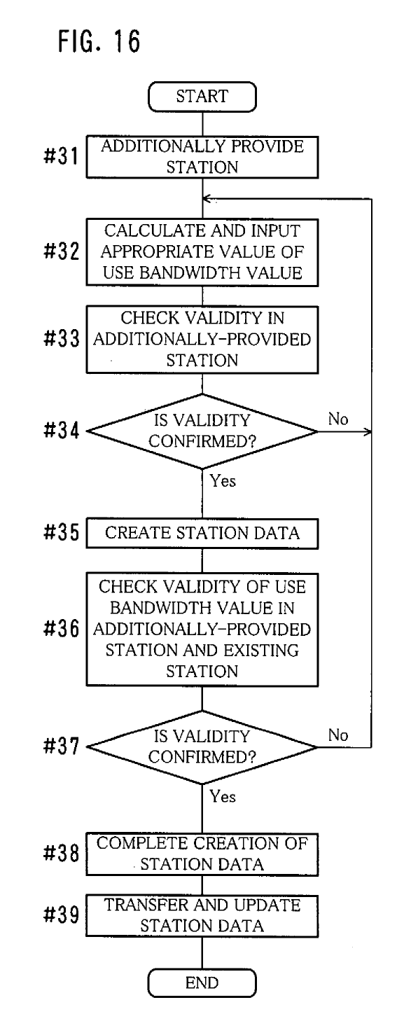

FIG. 16 is a flowchart for an exemplified operation of the mobile communication network system NS.

In FIG. 16, a station (a device) such as a radio network controller RNC or a node NE is additionally provided on the basis of operational facilities planning information or the like (#31). Referring to a set bandwidth value BE of an existing station, an appropriate value of a set bandwidth value BE of the additionally provided station is calculated and the calculated value is input as an optimum bandwidth value BS of the additionally provided station (#32). The validity of the input optimum bandwidth value BS in the additionally provided station is checked (#33). In step #33, for example, assuming that the optimum bandwidth value BS is set, it is checked whether or not it results in exceeding a maximum value settable in each device such as a line or a station or in the whole devices.

When the validity is confirmed through the check (Yes in #34), station data DN of the additionally provided station is created on the basis of the optimum bandwidth value BS (#35). The validity of the created station data DN is checked with respect to not only the additionally provided station but also existing stations (#36).

When the validity is confirmed through the check of step #36 (Yes in #37), the creation of the station data DN is completed (#38), the resultant station data DN is transferred to a file server of a network device through a station data transferring function so as to update the station data DN in the network device (#39).

When No in step #34 or step #37, the process returns to step #32, in which an appropriate value of the set bandwidth value BE in the additionally provided station is calculated again referring to the set bandwidth values BE of the existing stations.

It is noted that input in step #32 may be performed by a person in charge of maintenance.

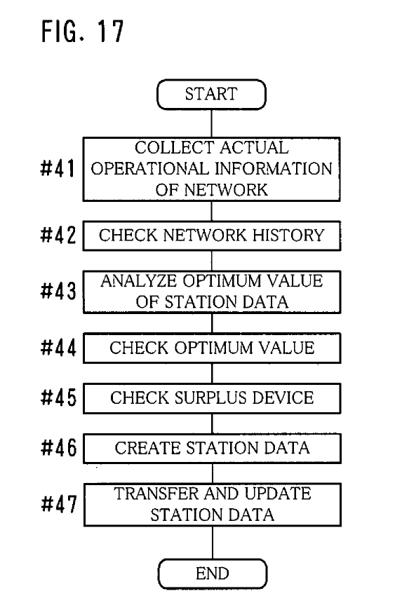

FIG. 17 is a flowchart illustrating another exemplified flow of the optimization process for station data DN performed in the station data creation system 12.

In FIG. 17, actual operational information JJ of the radio access network 1 is collected (#41), and the situation of the radio access network 1 is checked (#42). An optimum value of station data DN is analyzed (#43), it is checked whether or not the optimum value is settable (#44), a surplus device is checked (#45), station data is created (#46) and the station data DN is transferred and updated (#47).

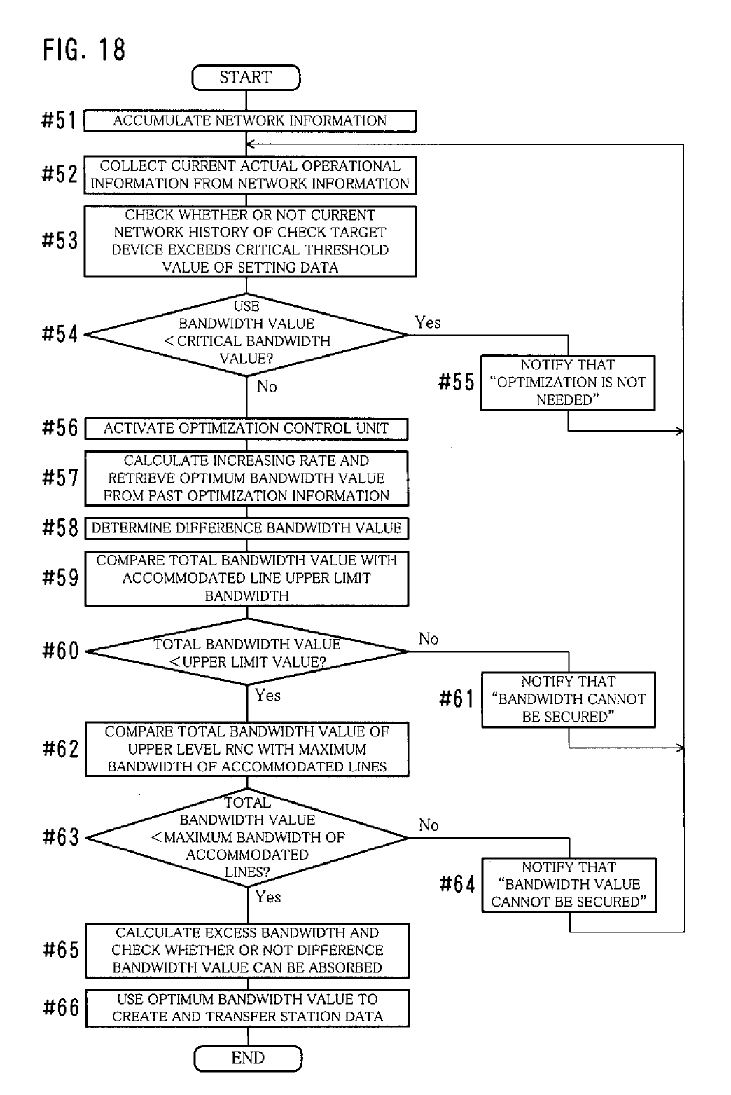

FIG. 18 is a flowchart illustrating an exemplified flow of an optimization process for station data DN of a bandwidth value performed in the maintenance network 2.

In FIG. 18, the network monitor system 11 collects situation information of the radio access network 1 through an existing process and stores the situation information as the network information D151 (#51).

The statistical information management unit 201 acquires, from the network monitor system 11, the network information D151 of a device (a node NE) corresponding to a current check target and stores the acquired information as the statistical information D251 (#52).

The network situation check unit 203 extracts a use bandwidth value BT, that is, a check target item, from the statistical information D251, and checks whether or not it exceeds a critical bandwidth value obtained from a critical threshold value DTG (#53).

When the use bandwidth value BT does not exceed the critical bandwidth value (Yes in #54), the statistical information management unit 201 is informed of “no need of optimization” (#55) and the process returns to step #52.

When the use bandwidth value BT exceeds the critical bandwidth value (No in #54), the optimization control unit 204 is activated (#56).

The optimization control unit 204 obtains an increasing rate RU of the use bandwidth value BT, retrieves the past optimization information D255 and extracts a bandwidth value having the closest increasing rate RU as optimization information (#57). The extracted optimization information is used as a virtual optimum value BSK.

A difference bandwidth value BN, that is, a difference between the virtual optimum bandwidth value BSK and a set bandwidth value BE included in the station set information D253 currently set, is obtained (#58).

With respect to the node NE corresponding to the check target, a total bandwidth value BGC, that is, a sum (ALL-VC) of set bandwidth values BE including the difference bandwidth value BN, is calculated to be compared with an accommodated line upper limit bandwidth BKJ (#59).

When the total bandwidth value BGC exceeds the accommodated line upper limit bandwidth BKJ (No in #60), it is informed that “a bandwidth value cannot be secured” (#61) and the process returns to step #52.

When the total bandwidth value BGC does not exceed the accommodated line upper limit bandwidth BKJ (Yes in #60), a total bandwidth value BGN with respect to a radio network controller RNC provided above the node NE corresponding to the check target is calculated to be compared with a maximum bandwidth of accommodated lines of the radio network controller RNC (#62).

When the total bandwidth value BGN exceeds the maximum bandwidth of accommodated lines of the radio network controller RNC (No in #63), it is informed that “a bandwidth value cannot be secured” (#64), and the process returns to step #52.

An excess bandwidth BY is calculated by using the bandwidth set information SB, the use bandwidth value BT and a safety threshold value DTA, and it is checked whether or not the difference bandwidth value BN can be absorbed by the calculated excess bandwidth BY. When it can be absorbed, the virtual optimum bandwidth value BSK is set as an optimum bandwidth value BS (#65). The optimum bandwidth value BS is used for creating station data DN (#66).

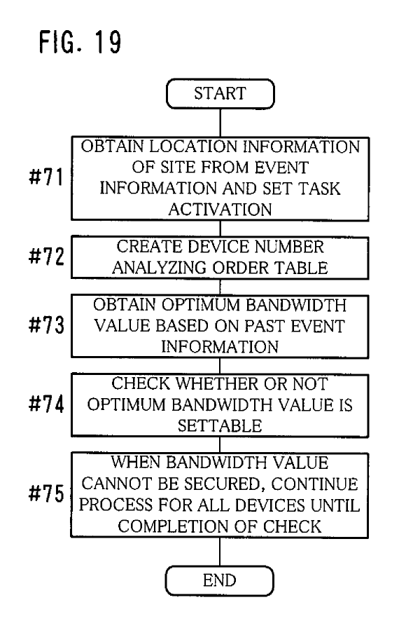

FIG. 19 is a flowchart illustrating a flow of an optimization process for station data performed when an event is to be held.

In FIG. 19, a person in charge of maintenance inputs event information through the maintenance terminal 13, so as to obtain location information of a site of the event and to set task activation time (#71).

A device number analyzing order table HJ in which devices are registered in the ascending order of distance from the location information of the site of the event is built (#72).

An event with contents close to those of the current event is extracted from past events, and an optimum bandwidth value BS is obtained based on a use bandwidth value BT of the extracted past event (#73).

It is checked whether or not the obtained optimum bandwidth value BS is settable (#74). In step #74, the process performed in steps #65 and #66 of FIG. 18 are executed. Alternatively, in step #74, the process performed in steps #58 through #66 may be executed. In this case, after the determined task activation time comes, a process with the contents the same as those of steps #65 and #66 is performed.

When it is determined that “a bandwidth value cannot be secured”, a device closest to the location information of the site of the event is extracted successively from the device number analyzing order table HJ, and a similar process is executed on all the extracted devices (#75). In step #75, when it is determined that “a bandwidth value cannot be secured” with respect to all the devices, the maintenance terminal 13 is informed that “a bandwidth value cannot be secured”.

The numerical values used as the use bandwidth value BT, the set bandwidth value BE, the difference bandwidth value BN, the critical threshold value DTG, the safety threshold value DTA and the like in the aforementioned examples and embodiment are mentioned merely as examples and any of various other numerical values may be employed instead.

In the above description, the process of steps #11, #21, #41 and #52 may be referred to as the first process; the process of steps #12, #22, #42 and #53 may be referred to as the second process; the process of steps #13, #23, #42 and #54 may be referred to as the third process; the process of steps #24 and #45 may be referred to as the fourth process; the process of steps #14, #25, #45 and #65 may be referred to as the fifth process; and the process of steps #15, #26, #46 and #66 may be referred to as the sixth process.

With respect to the network monitor system 11, the station data creation system 12, the maintenance terminal 13, the maintenance network 2 and the radio access network 1 mentioned in the aforementioned examples and embodiment, the architectures and the functions of the whole or respective units, the contents and orders of the processes and the timing of executing the processes, the items and the numerical values, the number and the arrangement of components, etc. may be appropriately modified in accordance with the spirit of the invention.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present inventions have been described in detail, it should be understood that the various changes, substitutions, and alterations could be made hereto without departing from the spirit and scope of the invention.

What is claimed is:

1. A computer-readable storage medium storing a computer program for optimizing station data used in a mobile communication network, the computer program allowing a computer to execute:
a process acquiring actual operational information indicating an actual operational history of the mobile communication network;
a process acquiring setting data corresponding to station data set for each node of the mobile communication network;
a process extracting, on the basis of the actual operational information and the setting data, a node or a channel expected to have increase in traffic and a node or a channel having a margin in traffic;
a process creating station data optimized in consideration of change of traffic to be set for the extracted node or a node including the extracted channel; and
a process transferring the created station data to the corresponding node for update.

2. The computer-readable storage medium according to claim 1,
wherein the process extracting a node or a channel includes:
a process extracting, as the node or the channel expected to have increase in traffic, a node or a channel containing an item which is included in the actual operational information and of which data exceeds a critical threshold value precedently set with respect to the item; and
a process extracting, as the node or the channel having a margin in traffic, one or more nodes or channels that together are capable of absorbing a sum of increase in traffic expected in the node or the channel that has been extracted as a node or a channel expected to have increase in traffic.

3. The computer-readable storage medium according to claim 1, wherein when an event is planned to be held in an area where the mobile communication network is provided, task activation time is determined on the basis of time when the event is held, and at least the process transferring the created station data is executed after the determined task activation time comes.

4. A computer-readable storage medium storing a computer program for optimizing station data used in a mobile communication network, the computer program allowing a computer to execute:
a first process acquiring actual operational information indicating an actual operational history of the mobile communication network;
a second process acquiring setting data corresponding to station data set for each node of the mobile communication network;
a third process, performed when an actual bandwidth value of a channel of a node included in the actual operational information exceeds a critical bandwidth value obtained on the basis of a set bandwidth value and a critical threshold value set correspondingly to the channel, extracting the channel as a target channel and a node including the target channel as a target node;
a fourth process determining, with respect to the target channel, an optimum bandwidth value corresponding to a bandwidth value to be set as an optimum value or a difference bandwidth value corresponding to a difference between the optimum bandwidth value and the set bandwidth value;
a fifth process extracting, from channels included in the target node, a channel having a bandwidth value margin, which is obtained from the actual operational information and also from the set bandwidth value and a safety threshold value precedently set, exceeding the difference bandwidth value as a surplus channel; and
a sixth process creating station data to be used for changing and optimizing bandwidth values of the target channel and the surplus channel extracted in the previous processes in order to update the target node.

5. The computer-readable storage medium according to claim 4, wherein, in the fourth process, an increasing rate of bandwidth values of the target channel is obtained, on the basis of the actual operational information, from a lowest value a of latest actual bandwidth values and a subsequent highest value b and elapse time elapsing between the values a and b is obtained, and
an increasing rate and elapse time the most similar to the obtained increasing rate and elapse time are extracted from the actual operational information of the past, and a maximum bandwidth value corresponding to the extracted increasing rate and elapse time is set as the optimum bandwidth value.

6. The computer-readable storage medium according to claim 4, wherein the fourth process includes a first check process performed after determining the difference bandwidth value for checking whether or not a value resulting from addition of a sum of bandwidth values of station data set for the target node and the difference bandwidth value exceeds an upper limit bandwidth value of accommodated lines of the target node.

7. The computer-readable storage medium according to claim 6, wherein the fourth process includes a second check process performed after the first check process for checking whether or not a value resulting from addition of a sum of bandwidth values of station data set for all nodes provided under an upper level node of the target node and the difference bandwidth value exceeds an upper limit bandwidth value of accommodated lines of the upper level node

8. The computer-readable storage medium according to claim 4, further allowing the computer to execute:
a process building a device number analyzing order table in which all nodes, excluding the target node, provided under an upper level node of the target node are registered in the ascending order of geographic distance from the target node; and
a process, performed when the surplus channel is unable to be extracted in the fifth process, extracting the surplus channel from channels included in a node determined in an order in accordance with the device number analyzing order table.

9. The computer-readable storage medium according to claim 4, wherein, when an event is planned to be held in an area where the mobile communication network is provided, task activation time is determined on the basis of time when the event is held, and the fifth process and the sixth process are executed after the determined task activation time comes.

10. A method for optimizing station data used in a mobile communication network, comprising
acquiring actual operational information indicating an actual operational history of the mobile communication network;
acquiring setting data corresponding to station data set for each node of the mobile communication network;
extracting, on the basis of the actual operational information and the setting data, a node or a channel expected to have increase in traffic and a node or a channel having a margin in traffic;
creating station data optimized in consideration of change of traffic to be set for the extracted node or a node including the extracted channel; and
transferring the created station data to the corresponding node for update.

11. An apparatus for optimizing station data used in a mobile communication network, comprising:
a first acquiring portion for acquiring actual operational information indicating an actual operational history of the mobile communication network;
a second acquiring portion for acquiring setting data corresponding to station data set for each node of the mobile communication network;
an extracting portion for extracting, on the basis of the actual operational information and the setting data, a node or a channel expected to have increase in traffic and a node or a channel having a margin in traffic;
a creating portion for creating station data optimized in consideration of change of traffic to be set for the extracted node or a node including the extracted channel; and
a transferring portion for transferring the created station data to the corresponding node for update.
